(19) United States
(12) Patent Application Publication
(10) Pub. No.: US 2003/0038770 A1
(43) Pub. Date: Feb. 27, 2003

(54) Liquid crystal display and method for driving the same

(75) Inventors: Sang-Chul Lee, Seongname-city (KR); Jin-Oh Kwag, Suwon-city (KR); Chung-Hyuk Shin, Suwon-city (KR); Jong-Hyon Park, Seoul (KR)

Correspondence Address: F. Chau & Associates, LLP, Suite 501, 1900 Hempstead Turnpike, East Meadow, NY, 11554, US

(73) Assignee: Samsung Electronics Co., Ltd.

(21) Appl. No.: 10/121,165

(22) Filed: Apr. 12, 2002

(30) Foreign Application Priority Data
Aug. 24, 2001 (KR) 2001-51356

(51) Int. Cl. G09G 3/36

(52) U.S. Cl. 345/102

(57) ABSTRACT

A liquid crystal display having a backlight with reduced noise and a method for driving the backlight is provided. The liquid crystal display includes a liquid crystal display panel and a backlight unit. The liquid crystal display panel has a plurality of pixels and a plurality of signal lines, and the plurality of signal lines transmit signals to the pixels. The backlight unit has at least two lamps spaced from each other for supplying light to the liquid crystal display panel, wherein the two lamps are separately turned on and off. The back light unit further includes a plurality of inverters, the plurality of inverters provide the lamps with a plurality of lamp driving signals for controlling the lamps, and the lamp driving signals are activated at different times.

### BACKGROUND OF THE INVENTION

(a) Field of the Invention

The present invention relates to a liquid crystal display and a method for driving the same and, more specifically, to a liquid crystal display having uniform brightness and a method for driving the same.

(b) Description of the Related Art

Liquid crystal displays typically include two substrates and a liquid crystal layer interposed between the substrates. The transmittance of light is controlled by the intensity of an electric field applied to the liquid crystal layer.

In a conventional liquid crystal display pixel, a storage capacitor and a liquid crystal capacitor are connected to a transistor, which in turn is connected at its gate to a gate line. The other terminal of the storage capacitor not connected to the transistor is connected to a previous gate line. The other terminal of the liquid crystal capacitor not connected to the transistor is connected to a common voltage. When the previous gate line is turned on while the subject gate line is in an off-state, the potential of the terminal connected to the transistor is changed. Such a potential change results in the change of transmittance of light. Accordingly, the brightness of a pixel row is changed with time.

A liquid crystal display which is of the passive type generally uses a backlight as a light source, such as a small fluorescent lamp. The backlight is typically driven by an inverter in the liquid crystal display. The brightness of the backlight varies with the amplitude of a dimming signal from the inverter.

The time-dependent intensities of light due to the previous gate driving mode and the time-dependent dimming interfere each other to cause a beat phenomenon. The flickering caused by the beat may be visible to a viewer. Thus, it is desirable to provide a liquid crystal display having uniform brightness.

### SUMMARY OF THE INVENTION

A liquid crystal display is provided, which includes: a liquid crystal display panel having a plurality of pixels and a plurality of signal lines, the plurality of signal lines transmitting signals to the pixels; and a backlight unit having at least two lamps spaced from each other for supplying light to the liquid crystal display panel, wherein the two lamps are separately turned on and off.

According to an embodiment of the present invention, each of the plurality of pixels includes a field generating electrode and a switching device connected to the field generating electrode. The plurality of signal lines comprise a plurality of gate lines and a plurality of data lines, each of the plurality of gate lines is connected to the switching device for transmitting gate signals to the liquid crystal panel and each of the plurality of data lines is connected to the switching device for transmitting image signals to the liquid crystal panel, and the switching device transmits the image signals to the field generating electrode.

Preferably, the liquid crystal display further includes a gate driver connected to the plurality of gate lines. And the liquid crystal display further includes a pair of data drivers connected to the plurality of data lines, the pair of data drivers comprise a first data driver connected to one side of the liquid crystal display panel and a second data driver connected to the other side of the liquid crystal display panel.

According to an embodiment of the present invention, the two lamps are alternatively turned on and off. The backlight unit further includes a plurality of inverters, the plurality of inverters provide the lamps with a plurality of lamp driving signals for controlling the lamps, and the lamp driving signals are activated at different times. The plurality of lamp driving signals are two signals, each having a phase difference of 180 degrees from the other.

Preferably, the liquid crystal display further includes a controller for receiving color signals from an external graphic controller and control signals for controlling display of the color signals, and for generating a plurality of signal line control signals connected to the plurality of the signal lines and a back light control signal connected to the backlight unit. The controller includes: a timing controller generating and outputting a counted pulse signal based on a plurality of signal line control signals; an integrator integrating the counted pulse signal to generate an integrated signal; and a comparator comparing the integrated signal with a predetermined reference signal to generate the backlight control signal and outputting the backlight control signal to the backlight unit.

A liquid crystal display is also provided, which includes: a liquid crystal display panel having a plurality of pixels and a plurality of signal lines, the plurality of signal lines transmitting signals to the pixels; and a backlight unit for supplying light to the liquid crystal display panel, wherein the backlight unit is controlled in synchronization with at least one of panel control signals for controlling the liquid crystal display panel.

According to an embodiment of the present invention, the backlight unit includes a light emitting lamp and an inverter providing the light emitting lamp with a lamp driving signal for controlling the light emitting lamp, and wherein the lamp driving signal is synchronized with one of the panel control signals of the liquid crystal display panel. Each of the plurality of pixels includes a field generating electrode and a switching device connected to the field generating electrode, the plurality of signal lines include gate lines connected to the switching devices to transmit scanning signals for controlling the switching devices and data lines connected to the switching device to transmit image signals, and the switching devices transmit the image signals to the field generating electrodes in response to the scanning signals.

Preferably, the liquid crystal display further includes a controller receiving from external color signals and control signals for controlling display of the color signals, generating the panel control signals of the liquid crystal display panel based on the control signals to provide the panel control signals together with the color signals for the liquid crystal display panel, and generating a backlight control signal based on one of the panel control signals to provide the backlight control signal for the inverter, and wherein the inverter generates the lamp driving signal based on the backlight control signal. The panel control signals include a vertical synchronizing signal and a horizontal synchronizing signal, and the backlight control signal is generated based on either the vertical synchronizing signal or the horizontal synchronizing signal. The backlight control signal is generated based on either a vertical synchronization start signal generated based on a vertical synchronization signal among the control signals or a horizontal synchronization start signal generated based on a horizontal synchronizing signal.

According to an embodiment of the present invention, the controller includes: a timing controller generating and outputting a counted pulse signal based on the panel control signals; an integrator integrating the counted pulse signal to generate an integrated signal; and a comparator comparing the integrated signal with a predetermined reference signal to generate the backlight control signal and outputting the backlight control signal to the inverter.

A method for driving a liquid crystal display having a liquid crystal display panel and a backlight unit providing light for the liquid crystal display panel is also provided. The method includes the steps of: receiving color signals and control signals for controlling display of the color signals; supplying the color signals and liquid crystal display panel control signals generated based on the control signals to the liquid crystal display panel; and generating a backlight control signal for controlling the backlight unit based on either the control signals or the panel control signals to drive the backlight unit.

According to an embodiment of the present invention, the step of generating the backlight control signal includes: generating a pulse signal synchronized with the control signal or the display panel control signals; integrating the pulse signal to generate an integrated signal; and comparing the integrated signal with a predetermined reference signal to generate the backlight control signal.

### BRIEF DESCRIPTION OF THE DRAWINGS

The features and advantages of the present invention will become more apparent from the detailed description of preferred embodiments with reference to the accompanying drawings, like reference numerals are used for description of like or equivalent parts or portions for simplicity of illustration and explanation:

FIG. 1 is a block diagram of a liquid crystal display according to an embodiment of the present invention;

FIG. 2 shows waveforms of lamp driving signals and brightness of a liquid crystal display panel according to an embodiment of the present invention;

FIG. 3 is a block diagram of an inverter usable in the circuit shown in FIG. 1;

FIG. 4 is a block diagram of another inverter usable in the circuit shown in FIG. 1;

FIG. 5 is a block diagram of a liquid crystal display according to another embodiment of the present invention;

FIG. 6 shows exemplary waveforms of a vertical synchronizing start signal, a counted pulse signal, an integrated signal, and an inverter control signal according to the present invention; and

FIGS. 7 to 9 are timing diagrams of signals from the circuit of FIG. 5.

### DETAILED DESCRIPTION OF PREFERRED EMBODIMENTS

The features and advantages of the present invention will become more apparent from the detailed description of preferred embodiments with reference to the accompanying drawings, like reference numerals are used for description of like or equivalent parts or portions for simplicity of illustration and explanation.

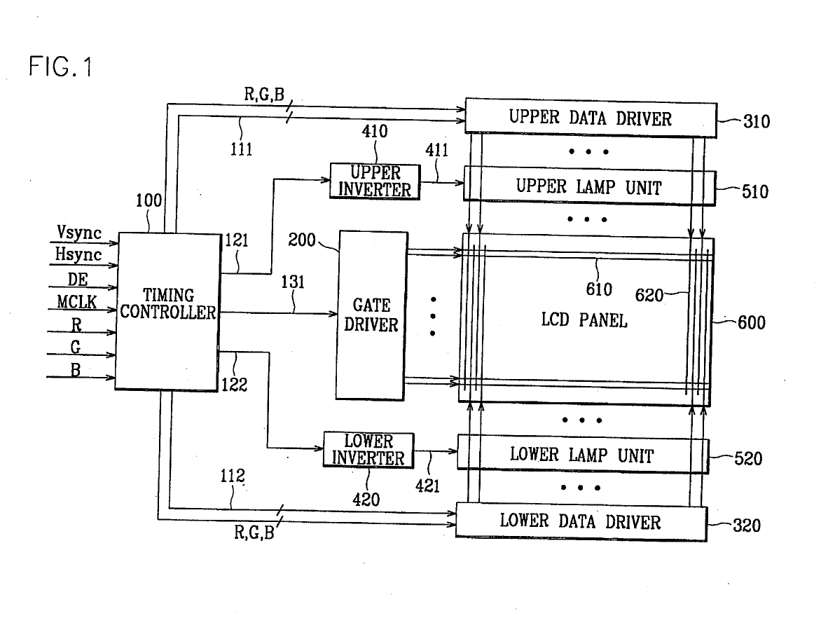

FIG. 1 is a block diagram of a liquid crystal display according to an embodiment of the present invention.

Referring to FIG. 1, the liquid crystal display according to an embodiment of the present invention includes a liquid crystal display panel 600, a timing controller 100, a gate driver 200, a pair of data drivers having an upper data driver 310 and a lower data driver 320, a pair of inverters having an upper inverter 410 and a lower inverter 420, and a pair of lamp units having an upper lamp unit 510 and a lower lamp unit 520.

The liquid crystal display panel 600 includes a plurality of pixels (not shown) in a matrix and a plurality of gate lines 610 and a plurality of data lines 620 for transmitting signals to the pixels. Each pixel has a thin film transistor (not shown) and an electric-field generating electrode connected to the thin film transistor. The thin film transistor is a switching device having three terminals, and is connected to the gate lines 610 and data lines 620. The plurality of gate lines 610 are for transmitting scanning signals or gate signals and the plurality of data lines 620 are for transmitting image signals or data signals. A plurality of signal lines (now shown) for transmitting common electrode signals can also be provided on the panel 600. The thin film transistor transmits image signals from the data lines 620 to the electric-field generating electrode in response to the scanning signals from the gate lines 610.

The upper lamp unit 510 and the lower lamp unit 520 spaced from each other are positioned at upper and lower sides of the liquid crystal display panel 600, respectively, or are positioned under upper and lower portions of back surface of the liquid crystal display panel 600. According to an embodiment of the present invention, the upper lamp unit 510 and the lower lamp unit 520 are connected to the upper converter 410 and the lower inverter 420, respectively, for controlling the lamp units 510 and 520, respectively.

The gate driver 200 connected to the gate lines 610 to provide the scanning signals therefor is located at one side of the liquid crystal display panel 600. The upper and lower data drivers 310 and 320 connected to the data lines 620 providing the data signals therefor are located at upper and the lower sides of the liquid crystal display panel 600, respectively. According to an embodiment of the present invention, the upper and the lower data drivers 310 and 320 are preferably connected to odd data lines and even data lines, respectively. However, one skilled in the art can readily appreciate that other ways of connecting the data drivers 310 and 320 to the data lines 620 can also made.

The gate driver 200, the data drivers 310 and 320, and the inverters 410 and 420 are connected to the timing controller 100 to be controlled thereby, and this is described below.

The timing controller 100 receives color signals R (red), G (green), and B (blue) from an external graphic controller (not shown), and various timing signals for controlling display of the color signals. The various timing signals includes a vertical synchronizing signal Vsync, a horizontal synchronizing signal Hsync, a data enable signal DE, and a main clock signal MCLK. In addition, the timing controller 100 generates a gate driver control signal 131 for controlling the gate driver 200 and data driver control signals 111 and 112 for controlling the data drivers 310 and 320 based on the timing signals, and transmits the gate driver control signal 131 to the gate driver 200 and the data driver control signals 111 and 112 to the data drivers 310 and 320. At this time, the color signals R, G, and B are provided for the data drivers 310 and 320 together with the data driver control signals 111 and 112. The gate driver 200 sequentially applies the gate signals to the gate lines 610 of the liquid crystal display panel 600 in response to the gate driver control signal 131, thereby turning on or off the thin film transistors connected to the gate lines 610. The data drivers 310 and 320 select and apply the image signals corresponding to the color signals R, G, and B to the data lines 620 based on the data driver control signals 111 and 112. The field generating electrode receives the image signals to display images when the thin film transistor is turned on.

In addition, the timing controller 100 generates inverter control signals 121 and 122 for controlling the upper and lower inverters 410 and 420 based on the timing signals, and outputs the inverter control signals 121 and 122 to the upper and lower inverters 410 and 420, respectively. The respective inverters 410 and 420 provide lamp driving signals 411 and 421 for controlling the upper and lower lamp units 510 and 520 based on the inverter control signals 121 and 122. The upper and lower lamp units 510 and 520 are turned on and off in accordance with the lamp driving signals 411 and 421, respectively.

According to a preferred embodiment of the present invention, the upper lamp unit 510 has a turn on/off period which is different from the period of turn on/off of the lower lamp unit 520. Preferably, the upper and the lower lamp units 510 and 520 are alternatively turned on and off.

For example, the lamp driving signals 411 and 421 applied to the upper and lower lamp units 510 and 520 have a phase difference, such as inverted phases or a phase difference of 180 degrees. In this way, the brightness of the liquid crystal display panel 600 can be uniformly controlled.

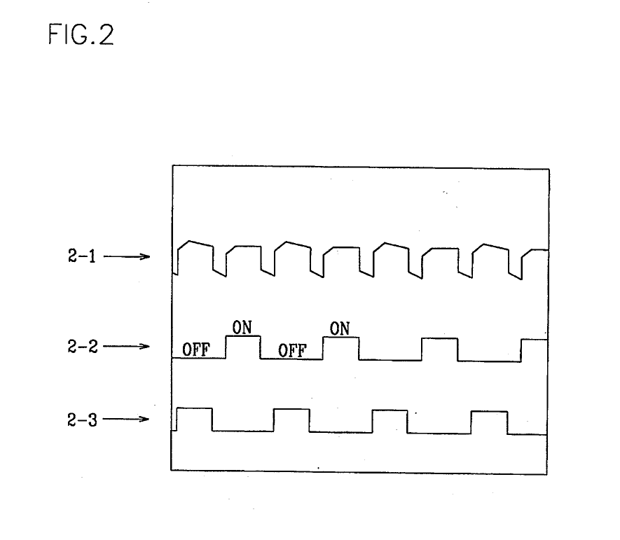

FIG. 2 shows waveforms 2-2 and 2-3 of the lamp driving signals 411 and 421 having the phase difference of 180 degrees, and brightness 2-1 of the liquid crystal display panel 600. Referring to FIG. 2, since the ON periods of the lamp driving signals 411 and 421 are shorter than OFF periods, the brightness 2-1 of the liquid crystal 20 display panel 600 is periodically changed. However, because the period of low brightness is much shorter than the period of high brightness, total brightness change of the liquid crystal display panel 600 is very small. As a result, uniform brightness of the liquid crystal display panel 600 is maintained most of the time. And this reduces brightness variation caused by a voltage change during driving a previous gate line and caused by time-dependent dimming of the backlight.

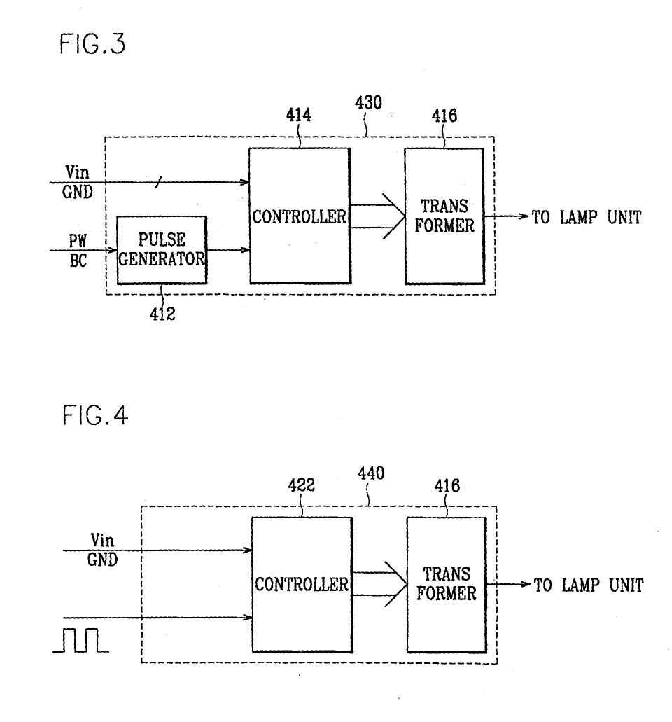

FIG. 3 shows a block diagram of an exemplary inverter 430 for the upper and lower inverters 410 and 420 in FIG. 1, which includes a pulse generator 412, a controller 414, and a transformer 416.

The pulse generator 412 is initiated by a power on/off signal PW supplied from an external device, and generates a pulse signal based on the inverter control signal 121 or 122 (in FIG. 1) such as a brightness control signal BC from the timing controller 100 to provide for the controller 414. A width, an amplitude, and a count of the generated pulses can be controlled based on the brightness control signal BC.

The controller 414 selects either a voltage Vin or GND in response to the pulse signal from the pulse generator 412 and provides the selected voltage Vin or GND for the transformer 416 as the inverter control signal. In response to this signal, the transformer 416 applies the inverter control signal to the upper and the lower lamp units 510 and 520 (in FIG. 1).

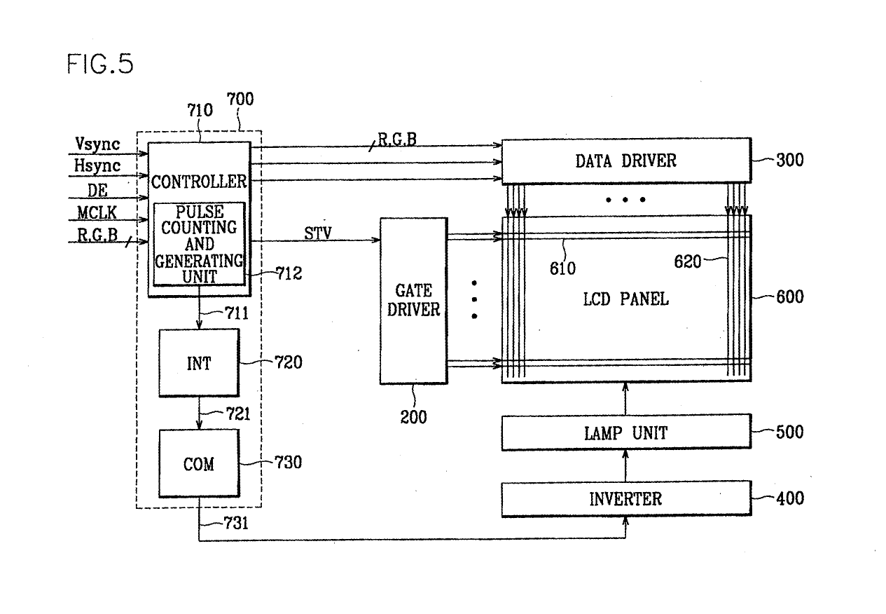

FIG. 4 shows a block diagram of another exemplary inverter 440 for the upper and lower inverters 410 and 420 in FIG. 1, which includes a controller 422 and a transformer 416. As compared with FIG. 3, the inverter 440 does not include a pulse generator 412 (in FIG. 3). Therefore, except that the inverter control signals 121 and 122 (in FIG. 1) supplied from the timing controller 100 (in FIG. 1) are pulse signals, the operation is the same as compared with FIG. 3.

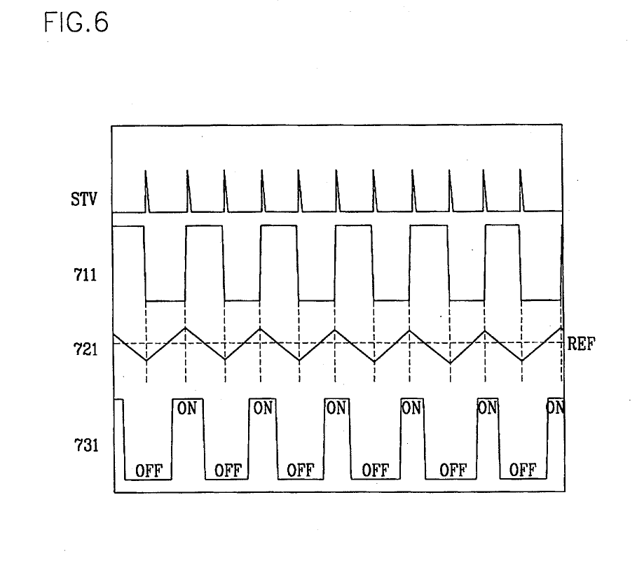

FIG. 5 is a block diagram of a liquid crystal display according to another embodiment of the present invention.

Referring to FIG. 5, the liquid crystal display includes a liquid crystal display panel 600, a lamp unit 500 disposed at one side of the liquid crystal display panel 600, an inverter 400 for controlling the lamp unit 500, a gate driver 200, a data driver 300, and a controller 700 for controlling them. As compared with FIG. 1, elements of the liquid crystal display having the same numerals are configured and functioned the same, except there is only a single lamp unit 500, inverter 400, and data driver 300, and the function of the timing controller (reference number 100 of FIG. 1) is somewhat different from the controller 700. According to the preferred embodiment of the present invention shown in FIG. 5, the liquid crystal display is not dual bank type having two data drivers but single bank type. Therefore, data lines 620 of the liquid crystal display panel 600 are connected to one data driver 300.

The controller 700 includes a timing controller 710 having a pulse counting and generating unit 712, an integrator 720, and a comparator 730, which are sequentially connected.

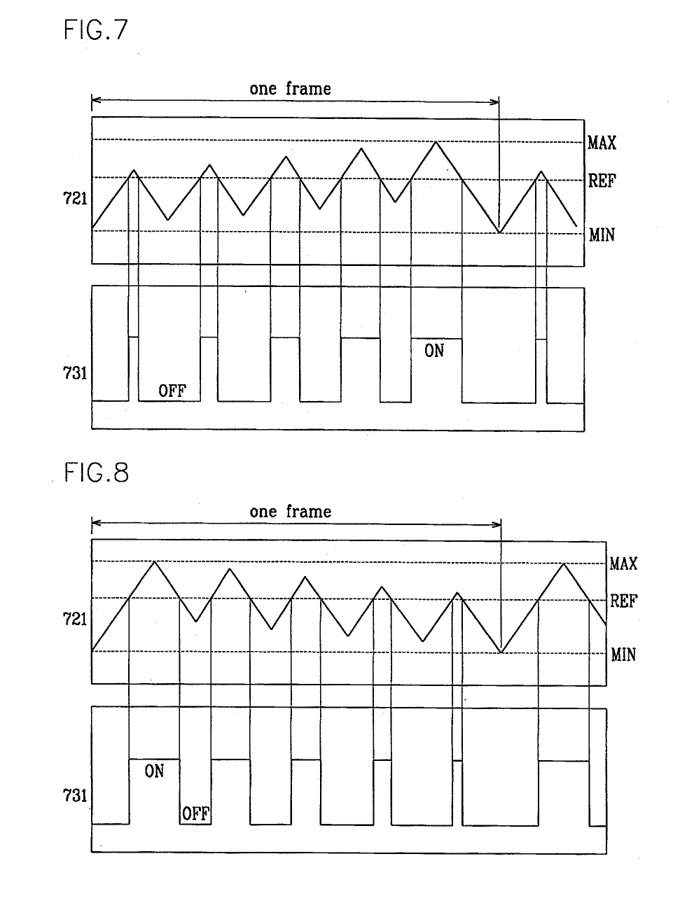

A method for driving the lamp unit 500 of the liquid crystal display will be described with reference to the FIGS. 5 and 6.

The timing controller 710 receives color signals R (red), G (green) and B (blue) from an external graphic controller (not shown), and various control signals for controlling display of the color signals. The various control signals includes a vertical synchronizing signal Vsync, a horizontal synchronizing signal Hsync, a data enable signal DE, and a main clock signal MCLK. The pulse counting and generating unit 712 generates a vertical synchronizing start signal STV based on the vertical synchronizing signal Vsync, counts pulses of the vertical synchronizing start signal STV, and provides a counted pulse signal 711 for the integrator 720.

FIG. 6 shows exemplary waveforms of the vertical synchronizing start signal STV, the counted pulse signal 711, an integrated signal 721, and an inverter control signal 731. Referring to FIG. 6, one pulse of the counted pulse signal 711, the integrated signal 721, and the inverter control signal 731 is generated for every two pulses of the vertical synchronizing start signal STV. The integrator 720 integrates the counted pulse signal 711 to obtain an integrated signal 721 having a chopping waveform, and outputs the integrated signal 721 to the comparator 730. The comparator 730 compares the integrated signal 721 with a predetermined reference signal REF to generate an inverter control signal 731, and outputs the inverter control signal 731 to the inverter 400 (in FIG. 5). The inverter 400 (in FIG. 5) drives the lamp unit 500 based on the inverter control signal 731.

An amplitude, a width, and a number, etc. of the counted pulse signal 711 are various, and thus the integrated signal 721 and the inverter control signal 731 can be changed.

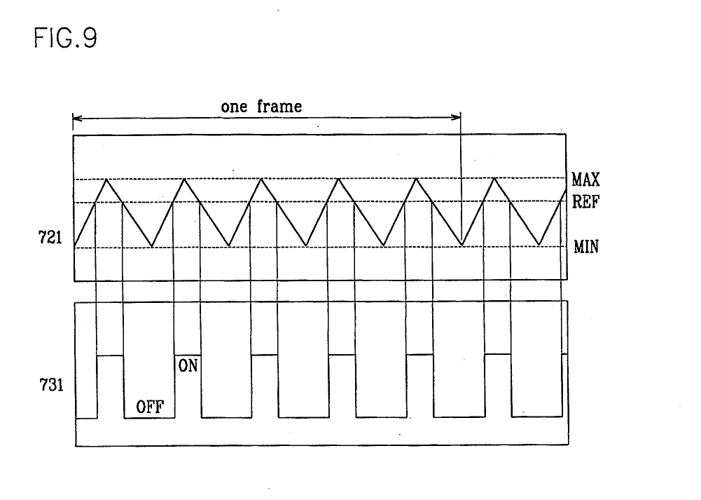

FIGS. 7 to 9 are timing diagrams of the integrated signal 721 and the inverter control signal 731.

FIGS. 7 and 8 show exemplary waveforms of the integrated signal 721 having non-uniform peak values within one frame, while FIG. 9 shows an example having uniform peak values. In FIG. 7 or FIG. 8, the integrated signal 721 varies within the one frame in the range of MIN to MAX. Referring to FIGS. 7 to 9, an ON period of the inverter control signal 731 is defined as a period that the value of the integrated signal 721 is equal to or larger than the value of the reference signal REF. FIG. 7 shows the ON period is longer as the signal approaches the end of the frame. In contrast, FIG. 8 shows that the ON period is shorter as the signal approaches the end of the frame. Whereas, FIG. 9 shows a constant ON period through the frame.

To generate the signals shown in FIGS. 7 and 8, the pulse counting and generating unit 712 (in FIG. 5) is configured to output a pulse signal as output from the inverter 400 (in FIG. 5). Thus, an inverter such as the inverter 400 is incorporated within the pulse counting and generating unit 712.

According to this illustrative embodiment of the present invention, the inverter control signal 731 is generated based on the vertical synchronizing start signal STV. However, it can also be generated based on the vertical synchronizing signal Vsync, the horizontal synchronizing signal Hsync, or a horizontal synchronizing start signal STH generated from the horizontal synchronizing signal Hsync.

As described above, the liquid crystal display of the present invention generates the inverter control signal in synchronization with control signals of the liquid crystal display panel such as the vertical synchronizing signal, etc., to coincide the brightness change period, thereby reducing brightness variation.

While this invention has been described in connection with the preferred embodiments, it is to be understood that the invention is not limited to the disclosed embodiments, but, on the contrary, is intended to cover various modifications and equivalent arrangements included within the sprit and scope of the appended claims.

What is claimed is:

1. A liquid crystal display comprising:
a liquid crystal display panel having a plurality of pixels and a plurality of signal lines, the plurality of signal lines transmitting signals to the pixels; and
a backlight unit having at least two lamps spaced from each other for supplying light to the liquid crystal display panel,
wherein the two lamps are separately turned on and off.

2. The liquid crystal display of claim 1, wherein each of the plurality of pixels comprises a field generating electrode and a switching device connected to the field generating electrode.

3. The liquid crystal display of claim 2, wherein the plurality of signal lines comprise a plurality of gate lines and a plurality of data lines, each of the plurality of gate lines is connected to the switching device for transmitting gate signals to the liquid crystal panel and each of the plurality of data lines is connected to the switching device for transmitting image signals to the liquid crystal panel, and the switching device transmits the image signals to the field generating electrode.

4. The liquid crystal display of claim 3, further comprising a gate driver connected to the plurality of gate lines.

5. The liquid crystal display of claim 3, further comprising a pair of data drivers connected to the plurality of data lines, the pair of data drivers comprise a first data driver connected to one side of the liquid crystal display panel and a second data driver connected to the other side of the liquid crystal display panel.

6. The liquid crystal display of claim 1, wherein the two lamps are alternatively turned on and off.

7. The liquid crystal display of claim 1, wherein the backlight unit further comprises a plurality of inverters, the plurality of inverters provide the lamps with a plurality of lamp driving signals for controlling the lamps, and the lamp driving signals are activated at different times.

8. The liquid crystal display of claim 7, wherein the plurality of lamp driving signals are two signals, each having a phase difference of 180 degrees from the other.

9. The liquid crystal display of claim 1, further comprising a controller for receiving color signals from an external graphic controller and control signals for controlling display of the color signals, and for generating a plurality of signal line control signals connected to the plurality of the signal lines and a back light control signal connected to the backlight unit.

10. The liquid crystal display of claim 9, wherein the controller comprises:
a timing controller generating and outputting a counted pulse signal based on a plurality of signal line control signals;
an integrator integrating the counted pulse signal to generate an integrated signal; and
a comparator comparing the integrated signal with a predetermined reference signal to generate the backlight control signal and outputting the backlight control signal to the backlight unit.

11. A liquid crystal display comprising:
a liquid crystal display panel having a plurality of pixels and a plurality of signal lines, the plurality of signal lines transmitting signals to the pixels; and
a backlight unit for supplying light to the liquid crystal display panel,
wherein the backlight unit is controlled in synchronization with at least one of panel control signals for controlling the liquid crystal display panel.

12. The liquid crystal display of claim 11, wherein the backlight unit comprises a light emitting lamp and an inverter providing the light emitting lamp with a lamp driving signal for controlling the light emitting lamp, and wherein the lamp driving signal is synchronized with one of the panel control signals of the liquid crystal display panel.

13. The liquid crystal display of claim 11, wherein each of the plurality of pixels includes a field generating electrode and a switching device connected to the field generating electrode, the plurality of signal lines include gate lines connected to the switching devices to transmit scanning signals for controlling the switching devices and data lines connected to the switching device to transmit image signals, and the switching devices transmit the image signals to the field generating electrodes in response to the scanning signals.

14. The liquid crystal display of claim 13, further comprising a controller receiving from external color signals and control signals for controlling display of the color signals, generating the panel control signals of the liquid crystal display panel based on the control signals to provide the panel control signals together with the color signals for the liquid crystal display panel, and generating a backlight control signal based on one of the panel control signals to provide the backlight control signal for the inverter, and wherein the inverter generates the lamp driving signal based on the backlight control signal.

15. The liquid crystal display of claim 14, wherein the panel control signals include a vertical synchronizing signal and a horizontal synchronizing signal, and the backlight control signal is generated based on either the vertical synchronizing signal or the horizontal synchronizing signal.

16. The liquid crystal display of claim 14, wherein the backlight control signal is generated based on either a vertical synchronization start signal generated based on a vertical synchronization signal among the control signals or a horizontal synchronization start signal generated based on a horizontal synchronizing signal.

17. The liquid crystal display of claim 14, wherein the controller comprises:
a timing controller generating and outputting a counted pulse signal based on the panel control signals;
an integrator integrating the counted pulse signal to generate an integrated signal; and
a comparator comparing the integrated signal with a predetermined reference signal to generate the backlight control signal and outputting the backlight control signal to the inverter.

18. A method for driving a liquid crystal display having a liquid crystal display panel and a backlight unit providing light for the liquid crystal display panel, the method comprising:
receiving color signals and control signals for controlling display of the color signals;
supplying the color signals and liquid crystal display panel control signals generated based on the control signals to the liquid crystal display panel; and
generating a backlight control signal for controlling the backlight unit based on either the control signals or the panel control signals to drive the backlight unit.

19. The method of claim 18, wherein the step of generating the backlight control signal comprises:
generating a pulse signal synchronized with the control signal or the display panel control signals;
integrating the pulse signal to generate an integrated signal; and
comparing the integrated signal with a predetermined reference signal to generate the backlight control signal.

20. The method of claim 18, wherein the backlight unit comprises at least two lamps spaced from each other.

21. The method of claim 20, wherein the two lamps are alternatively turned on and off.
